(19) United States
(12) Patent Application Publication
(10) Pub. No.: US 2007/0220301 A1
(43) Pub. Date: Sep. 20, 2007

(54) Remote access control management module

(75) Inventors: Michael Brundridge, Georgetown, TX (US); Paul Vancil, Austin, TX (US)

Correspondence Address: BAKER BOTTS, LLP, 910 LOUISIANA, HOUSTON, TX, 77002-4995, US

(73) Assignee: Dell Products L.P., Round Rock, TX (US)

(21) Appl. No.: 11/362,977

(22) Filed: Feb. 27, 2006

(51) Int. Cl. G06F 11/00

(52) U.S. Cl. 714/4

(57) ABSTRACT

A method of operating a remote access control unit which comprises first and second units each having an Ethernet port for remotely controlling modules of a server system, comprises the steps of powering up the server system; initializing the first unit into master mode thereby establishing a remote access through the first Ethernet port; assigning and storing a remote access address for the first unit; controlling modules of the server system by the first unit via a communication bus; initializing the redundant second unit into slave mode and disabling a coupling of the modules and the second unit; establishing a communication path between the first and second unit; and monitoring operability of the first unit; wherein upon failure of the first unit, the first unit is decoupled from the modules, the second unit is switched to master mode, thereby establishing a remote access through the second Ethernet port using the previously stored address and coupling the second unit with the modules for control operations.

### TECHNICAL FIELD

This invention relates to information handling systems, and more specifically to a blade chassis including a plurality of modules which are controlled by a remote access control/management control module.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

One type of information handling device is a server, which is a processor-based device on a network that manages network resources. As examples, a file server is dedicated to storing files, a print server manages one or more printers, a network server manages network traffic, and a database server processes database queries. A Web server services Internet World Wide Web pages.

In recent years, servers have been produced as “blade servers”, which are thin, modular electronic circuit boards, containing one or more microprocessors, memory, and other server hardware and firmware. Blade servers can be easily inserted into a space-saving rack with many other blade servers. Blade servers are sometimes referred to as a high-density servers. They are often used in clusters of servers dedicated to a single task.

### SUMMARY

A blade server may include a remote access control/management control module which allows for a remote control and remote management, for example, through out-of-band Ethernet messages. Without a functioning module however, no other module within the blade chassis can be powered on as well as no out-of-band alerts can be sent, and the chassis goes into fail safe mode and ramps all the fans to high speed.

In accordance with teachings of the present disclosure, a method for operating a redundant remote access control/management module allows for a more stable control of the different modules within a blade chassis by means of an Ethernet or serial connected terminal. Such a method of operating a remote access control unit which comprises a first unit having a first Ethernet port and a redundant second unit having a second Ethernet port for remotely controlling modules of a server system, comprises the steps of:
powering up the server system;
initializing the first unit into master mode thereby establishing a remote access through the first Ethernet port;
assigning and storing a remote access address for the first unit;
controlling modules of the server system by the first unit via a communication bus;
initializing the redundant second unit into slave mode and disabling a coupling of the modules and the second unit;
establishing a communication path between the first and second unit;
monitoring operability of the first unit;
   wherein upon failure of the first unit, the first unit is decoupled from the modules, the second unit is switched to master mode, thereby establishing a remote access through the second Ethernet port using the previously stored address and coupling the second unit with the modules for control operations.
   The step of monitoring can be performed by the steps of generating a heartbeat signal in the first unit; and monitoring the heartbeat signal in the second unit, wherein a failure signal is generated if the heartbeat signal is not present for a predetermined time. Upon failure of the first unit, the first unit can be reset by means of the second unit. A unit switched into master mode may establish a control coupling with the modules via an I²C bus and a communication coupling via its Ethernet port. A unit switched into slave mode may disable a control coupling with the modules. The control coupling may control at least one of the following: a I²C bus, a direct control bus, an Ethernet coupling and a serial bus. The initial settings for the first and second unit can be stored in EEPROM within the chassis. The assigned remote access address can be stored in the EEPROM. The assigned remote access address can be communicated to the second unit via the established communication path. The step of assigning an remote access address may use a DHCP protocol or a static IP address. An DHCP address can be confirmed by the second unit after failure of the first unit. The Ethernet port of the slave unit can be used to monitor functions of the slave unit.
   Alternatively, a method of operating a remote access control unit which comprises a first unit having a first Ethernet port and a redundant second unit having a second Ethernet port for remotely controlling modules of a server system, comprises the steps of:
powering up the server system;
initializing the both units and setting one unit into master mode thereby establishing a remote access through the first Ethernet port and setting the other unit into slave mode;
assigning and storing a remote access address for the master mode unit;
controlling modules of the server system by the first unit via a communication bus;
establishing a communication path between the master mode and slave mode unit;
monitoring operability of the master mode unit;
   wherein upon failure of the master mode unit, the slave mode unit is switched to master mode, thereby establishing a remote access through the second Ethernet port using the previously stored address.
   Upon failure the master mode unit can be decoupled from the modules and the salve mode unit can be coupled with the modules. The step of monitoring can be performed by the steps of generating a heartbeat signal in the master mode unit; and monitoring the heartbeat signal in the salve mode unit, wherein a failure signal is generated if the heartbeat signal is not present for a predetermined time. Upon failure of the master mode unit, the master mode unit can be reset by means of the slave mode unit. A unit switched into master mode can establish a control coupling with the modules via an I²C bus and a communication coupling via its Ethernet port. A unit switched into slave mode may disable a control coupling with the modules. The control coupling may control at least one of the following: a I²C bus, a direct control bus, an Ethernet coupling and a serial bus. The initial settings for the master mode and slave mode units can be stored in EEPROM within the chassis. The assigned remote access address can be stored in the EEPROM. The assigned remote access address can be communicated to the slave mode unit via the established communication path.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 is a front perspective view of a server system.

FIG. 2 is a rear perspective view of the server system of FIG. 1, showing various rear modules associated with the chassis.

FIG. 3 is a block diagram of the rear modules of FIG. 2.

FIG. 4 is an exemplary circuit diagram of the modules of a blade server chassis.

FIG. 5 is an embodiment of a DRACRAC/MC module according to the invention.

FIG. 6A-C are flow charts of the operation of a RAC/MC module as shown in FIG. 5.

### DETAILED DESCRIPTION

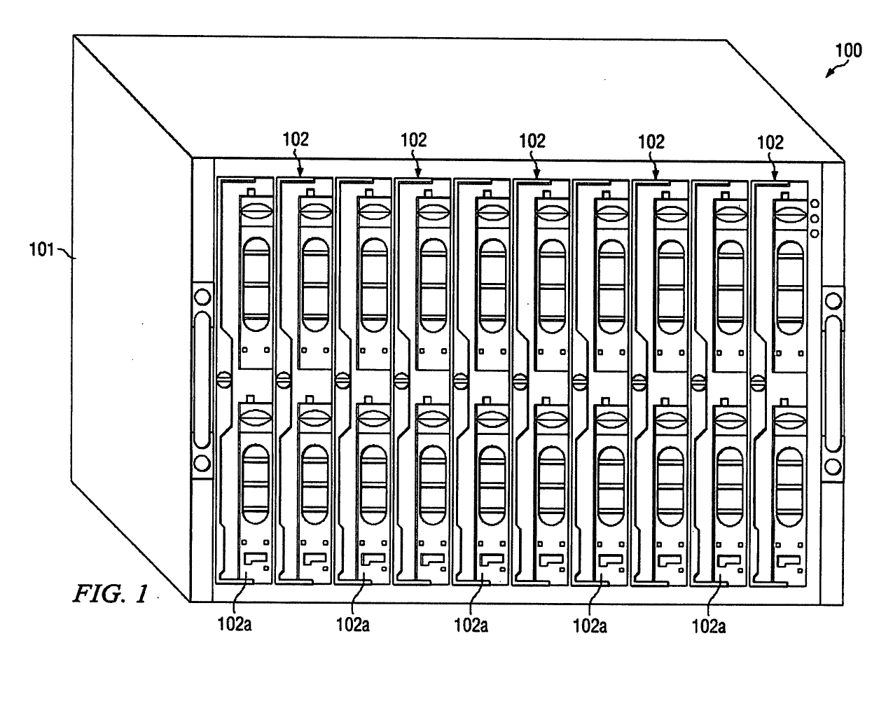

Preferred embodiments and their advantages are best understood by reference to FIGS. 1 through 7, wherein like numbers are used to indicate like and corresponding parts. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components. As indicated in the Background, one type of information handling system is a server system. In general terms, a server system communicates with one or more client systems for the purposes of exchanging information and performing transactions.

FIG. 1 is a front perspective view of a server system 100 enclosed within chassis/modular enclosure 101. Modular enclosure 101 accepts one or more server modules 102. In the example of this description, server system 100 is a “blade” modular enclosure, and each server module 102 is a server blade. As described in the Background, a server blade is a thin modular electronic circuit board containing one or more processors, memory, and other hardware and firmware. However, as mentioned above any other type of modular server or even modular computer system with a remote access capability can be provided with such a remote access control unit.

A blade server can be typically “hot pluggable”, meaning that it can be installed or removed while the rest of the server system 100 is running. A power-on button can be provided for which permits each blade to be independently powered on or off. In the example of FIG. 1, server system 100 accommodates ten server modules (blades) 102. In other embodiments there may be more or fewer server modules, and the modules need not be “blade” type modules. For example, the server modules 102 may be a type of server module referred to as a “brick” server module.

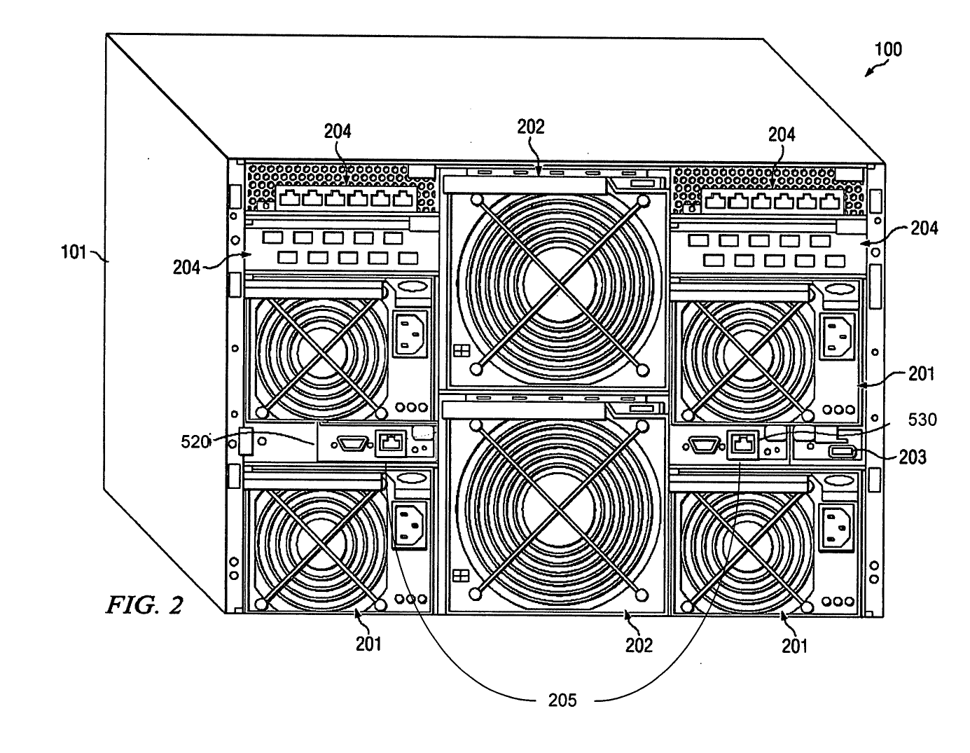

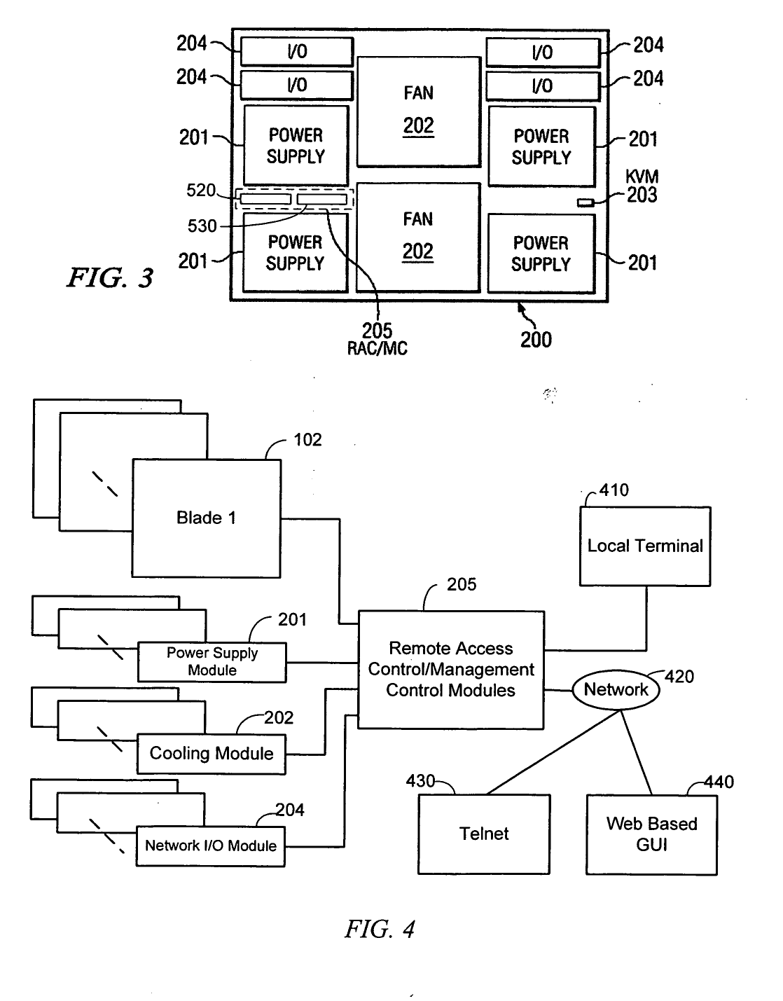

FIG. 2 is a back perspective view of server system 100, and various rear modules 201-205 associated with the chassis 101. FIG. 3 is a schematic view of the same rear modules.

Referring to both FIGS. 2 and 3, the rear modules include redundant power supplies 201, redundant cooling fans 202, and a keyboard, video, and mouse (KVM) switch 203. Four I/O modules 204 provide various I/O communication and network capabilities, such as for Ethernet or fibre channel connections. A RAC/MC (Remote Access Controller/Modular Chassis) unit 205 provides management of the chassis 101, blade servers 102, Power Supplies modules 201, Fan modules 202, analog and/or digital KVM module 203, and I/O modules 204 and can consist of separate modules 530, 520 as indicated in FIG. 2. Alternatively, both modules can be combined in a single unit and placed in a single slot of modular enclosure 101 as indicated in FIG. 3. Its tasks include health reporting, management, power management, thermal management, fabric consistency validation, event log reporting, user interfaces, alerting, and inventory reporting. RAC/MC unit 205 has remote access hardware for remote management. Chassis 101 has appropriate ports, such as Ethernet and fibre channel ports associated with the I/O modules 204. An analog KVM module 203 supports video and PS/2 connections, a digital KVM also supports an RJ45 Ethernet port for KVM over IP. The RAC/MC unit 205 and its modules 520, 530 each have serial and Ethernet connections each coupled with a communication network. Server system 100 communicates with remote information handling devices using a communication protocol over a network. The communication network may be an Ethernet network, Fast Ethernet or other type of local or wide area network (LAN or WAN), a point-to-point network provided by telephone services, or other type of communication network or combination of networks.

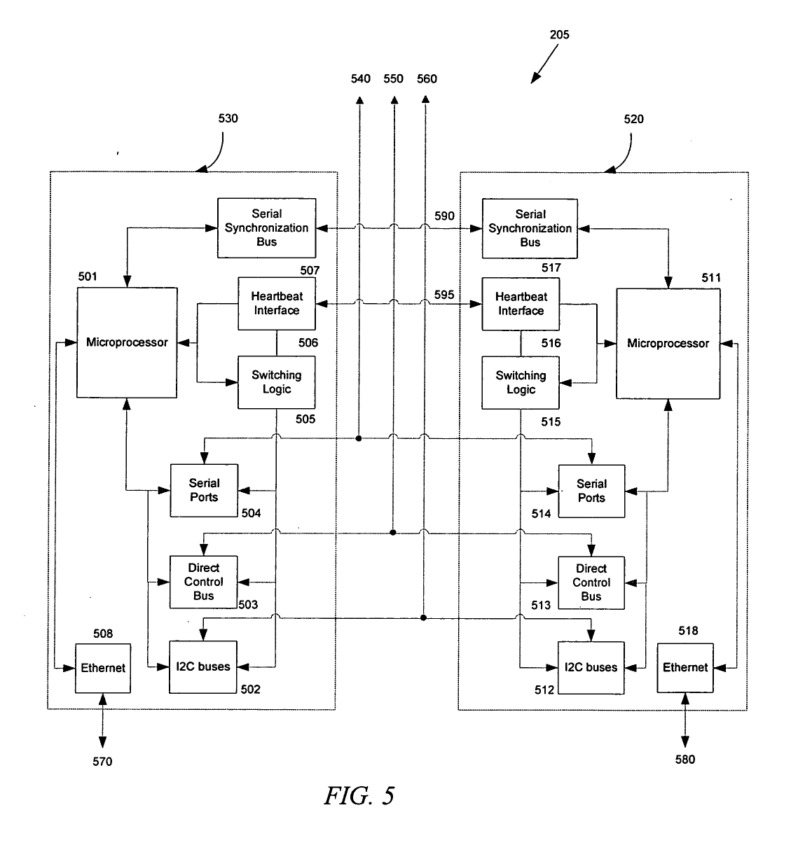

As explained below in more detail, the invention described herein is directed to the design and operation of a RAC/MC unit in a server, such as a blade server, brick server, or any other type of modular server system. FIG. 4 illustrates the internal and external coupling of the RAC/MC unit 205. RAC/MC unit 205 is coupled with all front and rear modules of the blade server as shown by the connections on the left side of FIG. 4. On the right side of the RAC/MC unit 205 in FIG. 4, the possible external components are shown. For example, the RAC/MC can be coupled with a local terminal 410 through a local serial port. Also, the RAC/MC unit 205 can be connected to remote control units, such as, a Telnet service 430 or a web based graphical user interface 440 through an Ethernet network connection.

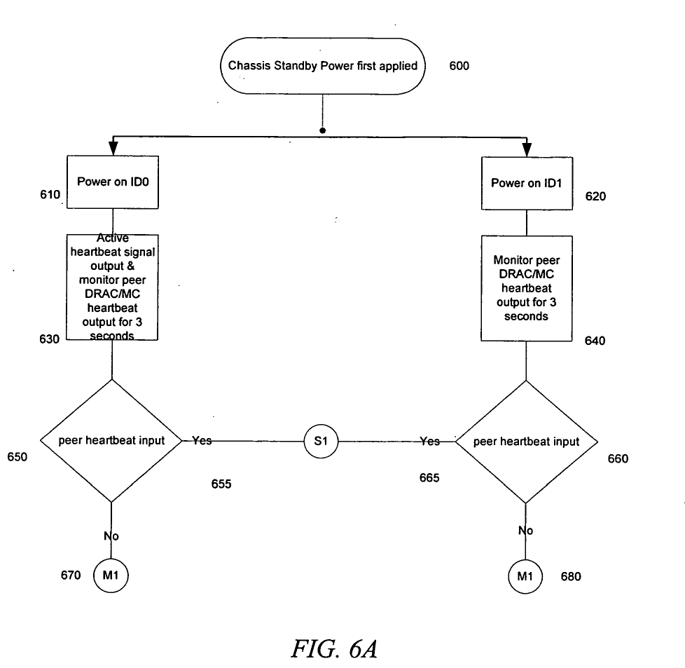

As mentioned above, the RAC/MC unit 205 is used to control by an external remote control unit all modules within a blade chassis through its Ethernet or serial coupling. Thus, if the RAC/MC fails to operate properly and is rendered inoperable, there is no possibility to have control over the chassis and, thus, the chassis will go into a fail safe mode. To resolve this issue, one exemplary embodiment of an RAC/MC unit 205 comprises a redundancy as shown in FIG. 5.

In FIG. 5, the RAC/MC unit 205 consists of a master RAC/MC module 530 and a slave RAC/MC module 520. Both modules can provide for the identical hardware and may comprise a main RAC/MC microprocessor 501, 511 which is coupled to a serial synchronization bus 507. The serial synchronization buses 507 and 517 of the master module 530 and the slave module 520 are coupled to provide a primary communication path 590 between the two modules. Furthermore, each module comprises a heartbeat device 506, 516, a direct control bus logic device 503, 513, a switching logic device 505, 515, and I²C buses 502, 512, each coupled with the microprocessor 501, 511, respectively. Each module 520, 530 comprises its own Ethernet unit 508, 518 and dedicated Ethernet port 570, 580. Also, serial ports 504, 514 are provided and linked together for communication between the microprocessors 501, 511. Only one of the modules 520, 530, however, actively controls these units to provide signals as will be explained in more detail below. The operation mode, namely master or slave mode, is setup by means of soft- or firmware during power up of the respective units. A combination of hardware logic and firmware logic provide for a voting system to determine who will be the master RAC/MC. Once a module has won the vote it will load the complete operating stack which includes the Ethernet TCP/IP stack, while the slave will not load the TCP/IP stack but will monitor the Ethernet port for link status. The I²C buses 502, 512 of the two modules 520, 530 are coupled to provide an internal communication path for controlling the modules of the chassis as indicated by port 560, and are isolated between the master and the slave RAC/MC by means of the switching logic 505 and 515. Also, the heartbeat device 506 and 516 of module 520 and 530 are linked together by coupling 595 as will be explained in more detail below.

The master RAC/MC module operating environment provides for the controlling Ethernet port 570 or 580 during normal operation of unit 205, i.e. when the designated module is in master mode. Thus, during normal operation, the slave Ethernet port connection 580 has no active TCP/IP stack and can be used to only monitor the status of the LINK status (cable connection to its own respective port). Similarly, the heartbeat device 506 of the master module 530 provides for a heartbeat signal which is monitored by the slave module's 520 heartbeat device 516. The heartbeat device, thus, provides for both functions, generating a heartbeat signal and for monitoring a heartbeat signal depending on whether the respective module is in master or slave mode.

During normal operation, the master module 530 performs all control and management functions through the I²C buses and the slave module 520 merely monitors the activities of the master module 530 for any type of malfunctioning. To this end, the switching logic controls who owns the buses based on who is master controls the 1²C isolation logic which can isolate the I²C busses, the direct control bus, and the serial buses of the slave module from actively transmitting any type of signal. A malfunctioning can be, for example, detected in one embodiment of the present application if a heartbeat signal is not generated, for example, for a time period of 5 seconds. Once such a malfunction is detected the slave module 520 will assume master role. Thus, the slave module 520 will become the master module and the defect master module 530 will be disconnected by means of the switching logic. To this end, the various buses (serial, I2C, direct control, etc.) will be isolated by means of the switching logic and are controlled as follows. If possible switching logic 505 will be controlled to de-couple from the I²C bus 560 and switching logic 515 is controlled to enable the slave modules 520 I²C buses. The direct control bus will be controlled to de-couple from the direct control bus port 550 and direct control logic device 513 is controlled to enable the slave modules 520 direct control bus. The serial bus 504 will be de-coupled from the serial bus port 540 by means of the switching logic 505 and serial port 514 will be enabled on module 520 by switching logic 515. In case of a total malfunctioning of the master module 530, no further action might be necessary and the slave module 520 can, for example, be able to actually reset the old master module and perform all other necessary couplings and de-couplings.

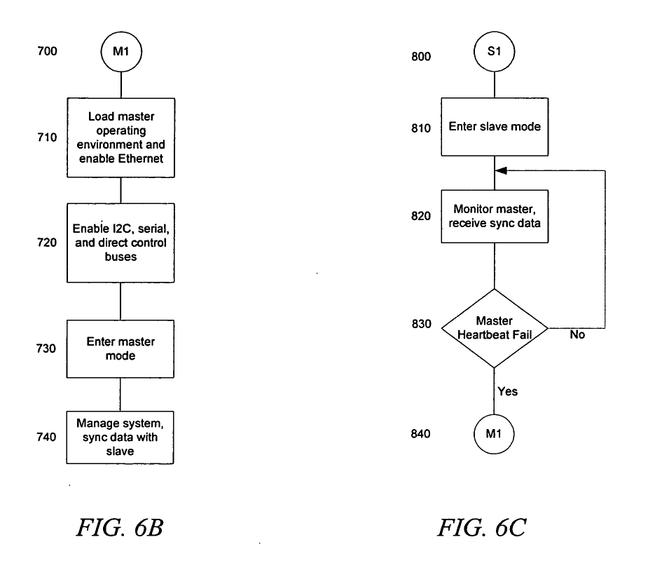

FIG. 6A-C shows flow charts of the operation of master and slave modules 530, 520. Within the chassis, when any of the power supply units 201 is coupled with an AC input power supply it will provide a standby supply voltage, for example 5V, on the internal standby rail in step 600 as shown in FIG. 6A. When this standby voltage is first applied to the rail, the two RAC/MC modules 530 and 520 will start their initial firmware load at roughly the same time in steps 610, 620, respectively. Both modules will reach a point in the boot process where they will enter the master RAC/MC election phase to elect a master RAC/MC. The module labeled as ID0 if present and functioning will generate an active heartbeat signal in step 630. In one embodiment, the ID0 module can also monitor the heartbeat of the ID1 module as indicated in step 630. ID1 module 520 monitors the heartbeat, for example, for 3 seconds, to initially determine whether the ID0 module 530 is present and operating properly in step 640. If in step 650 it has been decided that the ID0 module 530 functions properly, the ID0 module 530 enters master mode at 670 and module 520 enters into the slave mode in step 665. In master mode as shown in FIG. 6B, the module 520 loads its master operating environment and enables the Ethernet port 570 in step 710. In step 720 the I²C unit 502, the serial unit 504 and the direct control bus unit 503 are enabled. Thus, module 530 is set into master mode in step 730 and will manage the system, synchronize data with the slave module 720 in step 740.

However, if there is no functioning module 530, then module 520 will enter master mode at 680 and perform the steps 700-740 as discussed above. Otherwise, the slave module enters the slave mode in step 810 via step 665 as shown in FIG. 6C. To this end, after the initial power up, the slave continues to monitor the heartbeat signal of the master and synchronize data with the master as shown in steps 820 and 830 of FIG. 6C.

The active Ethernet port can, thus, be switched from module 530 to module 520. In other words, the so far established Ethernet connection is terminated and the Ethernet connection to the thus dormant module is then activated. This switching is performed in a way that the actual IP address used for that specific port is maintained as will be explained in more detail below. Therefore, externally no action will be necessary to maintain the functionality of the server system. In one embodiment, this is done by an RAC/MC firmware control. Only a master module has the TCP/IP stack loaded, so once a unit fails and is reset, its TCP stack is not loaded unless it is a master. When it becomes master, it will load the TCP stack. Thus, when module 530 fails, and module 520 assumes the master role, Ethernet connection 570 is disabled by RAC reset, and Ethernet connection 580 is loaded by firmware loading to become the master module. The I²C bus is used to control the internal units of the chassis, for example, via port 560. Thus, the switching logic 505 and 515 provide for the proper circuitry to deactivate and activate the respective units 502, 512, 503, 513, 504, and 514 to provide for only one unit controlling these buses and ports 540, 550, and 560.

In normal operation, module 530 is set up to control the I²C bus, direct control bus 550, serial buses 540, and the external Ethernet connection 570 while module 520 monitors the operation of module 530 for malfunctioning. The master module 530, thus, sets up a remote connection using the necessary protocol, such as any appropriate web protocol, a simple network management protocol (SNMP), or telnet protocol. Similarly, the I²C bus for controlling the different modules and units use an appropriate protocol for communication, such as Intelligent Platform Management Interface (IPMI) or Intelligent Platform Management Bus (IPMB) protocol. The serial communication bus is utilized for console redirection of the server blades and I/O modules. The serial synchronization bus 507 is used for communication between the master and the slave module 530, 520. Through this link, for example, date and time can be synchronized, exchange information about the Field Replaceable Unit (FRU) of master and slave module, baud rates, status, and upgrade information.

The heartbeat units 506 and 516 are the main devices to ensure proper operation of the master module 530 as explained above. Generally, most system failures will lead to a lack of the heartbeat signal, such as, when the masters firmware core locks up, the masters hardware has a fault, the masters network cable or connection is lost, the master is removed by the user, the master is restarted via the user or some event, etc. However, other events and monitoring techniques can be used instead or in addition. For example, the serial port or even the I²C bus could be used for sending and receiving a heartbeat signal. Also, the slave module could in addition monitor the signal traffic on any or all of the direct control bus, the serial connection, and the I²C bus for inconsistencies in the communications as, for example, previously defined or known to the system.

In one embodiment, the system can be set up in such a way that very little communication between the master and slave modules 530, 520 is necessary. For example, all system configurations and logs can be stored within the chassis in a non-volatile memory, such as, an EEPROM. In one embodiment the master module 530 can synchronize date and time with the slave module 520 whenever necessary, for example, if the user changes the time, at startup or at any other appropriate time. The FRU information can be exchanged or requested from the slave module, for example, when a factory FRU programming has been performed.

Master and Slave module do have the same internet protocol (IP) address in case a switchover from the master to the slave is performed. They also may have the same media access control (MAC) address. Thus, externally no changes appear to a remote user and a remote user will not face a communication gap or malfunctioning communication in the event of a switchover. In slave mode, module 520 will not respond to any requests of a user regarding the management of the chassis. This can only be performed by the master module. The IP address can be either predetermined, such as a fixed address, and can be known to the modules or be determined and communicated to both modules. If the master module determines the IP address it can store it within the chassis, for example, in the EEPROM or in any other appropriate memory. When the slave module 520 takes over control and becomes the master module, it will retrieve the last used IP address from, for example, the EEPROM located within the chassis. Alternatively, once the IP address has been established, it can be communicated to the slave module, for example, via the serial communication link. Also, in case of use of a dynamic host configuration protocol (DHCP) address, a newly assigned master can perform a check with the DHCP server to assure it has a valid lease on the IP address before continuing to bind the address. If the address is static, it can complete the bind and continue with chassis management responsibilities. The switchover, thus, includes a transfer of the exact network access including all addresses and using the same protocols. Hence, it can be ensured that no change is visible from the outside.

The master and slave modules 530 and 520 can either be provided within a single unit 205 as shown in FIG. 3 or they can be provided on separate modules within a chassis as shown in FIG. 2. A chassis may, thus, provide for a plurality of slave units/modules. Master and slave module can be identical in hardware and only after insertion into the server chassis, the respective master/slave-mode will be automatically determined as described above. Each slave unit and the master unit can constitute a separate module. This can be in particular beneficial, when only two modules are present. Whenever, the master module fails to operate properly, the slave unit will take over responsibilities as a new master unit and indicate to a user the failure of the master unit. The user can then remove the inoperable former master unit from the chassis while the server will remain filly functioning. Then, the user can insert a new slave module which will power up after insertion and serve as the new monitoring unit within the server chassis. The steps can be repeated if the new master unit fails. Thus, no down time of the system will occur.

If there are multiple slave units provided, each slave unit may have an assigned priority number. The slave unit with the highest priority number will then be the first to become a new master unit in case of a failure and so on. Exchange of failing modules can be performed as indicated above.

What is claimed is:

1. A method of operating a remote access control unit comprising a first unit having a first Ethernet port and a redundant second unit having a second Ethernet port for remotely controlling modules of a server system, the method comprising the steps of:
powering up the server system;
initializing the first unit into master mode thereby establishing a remote access through said first Ethernet port;
assigning and storing a remote access address for said first unit;
controlling modules of the server system by the first unit via a communication bus;
initializing said redundant second unit into slave mode and disabling a coupling of said modules and said second unit;
establishing a communication path between said first and second unit;
monitoring operability of the first unit;
wherein upon failure of the first unit, the first unit is decoupled from said modules, the second unit is switched to master mode, thereby establishing a remote access through the second Ethernet port using the previously stored address and coupling said second unit with said modules for control operations.

2. A method according to claim 1, wherein the step of monitoring is performed by the steps of:
generating a heartbeat signal in said first unit;
monitoring said heartbeat signal in said second unit, wherein a failure signal is generated if said heartbeat signal is not present for a predetermined time.

3. A method according to claim 1, wherein upon failure of the first unit, the first unit is reset by means of the second unit.

4. A method according to claim 1, wherein a unit switched into master mode is establishing a control coupling with said modules via an I²C bus and a communication coupling via its Ethernet port.

5. A method according to claim 1, wherein a unit switched into slave mode is disabling a control coupling with said modules.

6. A method according to claim 5, wherein the control coupling controls at least one of the following: a I²C bus, a direct control bus, an Ethernet coupling and a serial bus.

7. A method according to claim 1, wherein the initial settings for the first and second unit are stored in EEPROM within the chassis.

8. A method according to claim 7, wherein the assigned remote access address is stored in said EEPROM.

9. A method according to claim 1, wherein the assigned remote access address is communicated to said second unit via said established communication path.

10. A method according to claim 1, wherein the step of assigning an remote access address is using a DHCP protocol or a static IP address.

11. A method according to claim 9, wherein an DHCP address is confirmed by the second unit after failure of the first unit.

12. A method according to claim 1, wherein the Ethernet port of the slave unit is used to monitor functions of the slave unit.

13. A method of operating a remote access control unit comprising a first unit having a first Ethernet port and a redundant second unit having a second Ethernet port for remotely controlling modules of a server system, the method comprising the steps of:
powering up the server system;
initializing the both units and setting one unit into master mode thereby establishing a remote access through said first Ethernet port and setting the other unit into slave mode;
assigning and storing a remote access address for the master mode unit;
controlling modules of the server system by the first unit via a communication bus;
establishing a communication path between said master mode and slave mode unit;
monitoring operability of the master mode unit;
wherein upon failure of the master mode unit, the slave mode unit is switched to master mode, thereby establishing a remote access through the second Ethernet port using the previously stored address.

14. A method according to claim 13, wherein upon failure the master mode unit is decoupled from the modules and the salve mode unit is coupled with said modules.

15. A method according to claim 13, wherein the step of monitoring is performed by the steps of:
generating a heartbeat signal in said master mode unit;
monitoring said heartbeat signal in said salve mode unit, wherein a failure signal is generated if said heartbeat signal is not present for a predetermined time.

16. A method according to claim 13, wherein upon failure of the master mode unit, the master mode unit is reset by means of the slave mode unit.

17. A method according to claim 13, wherein a unit switched into master mode is establishing a control coupling with said modules via an I²C bus and a communication coupling via its Ethernet port.

18. A method according to claim 13, wherein a unit switched into slave mode is disabling a control coupling with said modules.

19. A method according to claim 18, wherein the control coupling controls at least one of the following: a I²C bus, a direct control bus, an Ethernet coupling and a serial bus.

20. A method according to claim 13, wherein the initial settings for the master mode and slave mode units are stored in EEPROM within the chassis.

21. A method according to claim 20, wherein the assigned remote access address is stored in said EEPROM.

22. A method according to claim 13, wherein the assigned remote access address is communicated to said slave mode unit via said established communication path.
